(19) United States
(12) Patent Application Publication
(10) Pub. No.: US 2026/0043646 A1
(43) Pub. Date: Feb. 12, 2026

(54) LINE SPECTROSCOPIC REFLECTOMETRY

(71) Applicant: SEOUL NATIONAL UNIVERSITY R&DB FOUNDATION, Seoul (KR)

(72) Inventors: Jeongmin KIM, Seoul (KR); Minchol LEE, Seoul (KR); Jaehyun PARK, Cheonan-si (KR)

(21) Appl. No.: 19/072,387

(22) Filed: Mar. 6, 2025

(30) Foreign Application Priority Data
Aug. 6, 2024 (KR) 10-2024-0104770

(51) Int. Cl. G01B 11/06; G01N 21/55

(52) U.S. Cl. CPC G01B 11/0625; G01N 21/55; G01B 2210/56

(57) ABSTRACT

The present disclosure relates to line spectroscopic reflectometry, and the line spectroscopic reflectometry according to the present disclosure is characterized by including a line beam forming part that generates a line beam from a light source irradiating a broadband wavelength; a bi-telecentric relay optical part that uses bi-telecentric optics to enlarge the line beam generated by the line beam forming part and vertically irradiates and reflects it onto a measurement object; a spectroscopic reflectance image acquisition part that separates the reflected line beam from the measurement object by wavelength to acquire a spectroscopic reflectance image; and an image analysis processing part that obtains a thickness of the measurement object from the spectroscopic reflectance image for a region where the line beam is irradiated onto the measurement object.

### CROSS-REFERENCE TO RELATED APPLICATION

This application claims the benefit of Korean Application No. 10-2024-0104770, filed Aug. 6, 2024, the disclosure of which is incorporated by reference herein in its entirety.

### 1. FIELD

The present disclosure relates to line spectroscopic reflectometry, and more specifically, to the line spectroscopic reflectometry that uses a light source with a finite wavelength range to obtain spectroscopic reflectance signals representing reflectance by wavelength and analyzes them to measure the thickness of a measurement object, where the measurement is performed in a line measurement method rather than a point measurement method thereby improving measurement speed.

### 2. BACKGROUND

Spectroscopic reflectometry is a non-contact optical measurement technique used to measure the thickness of optically transparent or translucent films or substrates.

If light with a wavelength λ is irradiated onto a measurement object, reflection occurs at each boundary surface of the medium, and due to interference phenomena, the final reflectance (R) signal varies in intensity depending on the thickness (d) and refractive index (n) of the object, as well as the light wavelength. Spectroscopic reflectometry uses a light source with a finite wavelength band to obtain spectroscopic reflectance signals that represent reflectance at each wavelength, and analyzes these signals, to estimate the thickness of the object.

Conventional spectroscopic reflectometry was developed to operate using a point measurement method, where a broadband light source provides point illumination to the measurement object. Therefore, when measuring the thickness of a large area, the measurement position must be changed repeatedly, and thus this point measurement method has inherent limitations for high-speed, large-area measurements.

In response to this limitation, spectroscopic reflectometry of a line measurement method has been attempted, wherein line illumination is irradiated onto the measurement object, and the thickness of the irradiated line area is measured simultaneously. However, this method suffers from several issues, including very low light utilization efficiency of the line light source, decreased measurement accuracy depending on the measurement position on the line, and variations in the incident and reflection angles of light depending on the measurement position on the line, which lead to different computational models for thickness estimation, resulting in significantly longer thickness estimation times.

### PRIOR ART DOCUMENT

### Patent Document

Japanese Laid-open Patent No. 2012-189406

### SUMMARY

Embodiments of the invention provide line spectroscopic reflectometry capable of simultaneously measuring the thickness of the area irradiated by a line beam in a line measurement manner by using bi-telecentric optics to generate a line beam that is incident and reflected perpendicularly regardless of the position within the field of view, thereby achieving high optical utilization efficiency, identical computational modeling for thickness estimation regardless of the position within the field of view, high measurement accuracy, a wide measurement range, and the capability for high-speed measurement and rapid thickness estimation.

Problems solved by the present disclosure are not limited to those mentioned above, and other problems not stated can also be clearly understood by those skilled in the art to which the present disclosure pertains based on the descriptions provided below.

Certain embodiments of the invention provide line spectroscopic reflectometry characterized by including a line beam forming part that generates a line beam from a light source irradiating a broadband wavelength; a bi-telecentric relay optical part that uses bi-telecentric optics to enlarge the line beam generated by the line beam forming part and vertically irradiates and reflects it onto a measurement object; a spectroscopic reflectance image acquisition part that separates the reflected line beam from the measurement object by wavelength to acquire a spectroscopic reflectance image; and an image analysis processing part that obtains a thickness of the measurement object from the spectroscopic reflectance image for a region where the line beam is irradiated onto the measurement object.

Here, the line spectroscopic reflectometry may further include a beam splitter that reflects the light irradiated from the line beam forming part toward the measurement object, and transmits the light reflected from the measurement object toward the spectroscopic reflectance image acquisition part.

Here, the line beam forming part may include a lens (L1) that converts the light irradiated from the light source into a circular collimated beam, and a cylindrical lens (Cyl1) that focuses the circular collimated beam in one direction.

Here, the line beam forming part may include a lens (L1) that makes a circular collimated beam from the light emitted from the light source, a Powell lens that is disposed behind the L1 and expands the light in one direction, a cylindrical lens (Cyl2) that is disposed behind the Powell lens and collimates the light, and a cylindrical lens (Cyl3) that is disposed behind the L1 and focuses the light in one direction.

Here, the bi-telecentric relay optical part may include a lens (L2) disposed at an image space's side and a lens (L3) disposed at an object space's side, and a distance between the L2 and the L3 may be equal to a sum of their focal lengths, and the line beam focused by the line beam forming part may be generated in front of the L2.

Here, the bi-telecentric relay optical part may further include a lens (L2) disposed at an image space's side, a lens (L3) disposed at an object space's side, and a lens (L6) disposed in front of the beam splitter at the line beam forming part's side, and the beam splitter may be disposed between the L2 and the L3, a distance between the L2 and the L3 may be equal to a sum of their focal lengths, so that the L2 and the L3 form bi-telecentric optics regarding the reflected light reflected from the measurement object, and a distance between the L6 and the L3 may be equal to a sum of their focal lengths, so that the L6 and the L3 form bi-telecentric optics regarding the incident light toward the measurement object.

Here, the spectroscopic reflectance image acquisition part may include spectroscopic optics that separates the line beam reflected from the measurement object by wavelength and a camera that acquires a two-dimensional spectroscopic reflectance image from the spectroscopic optics, and may further include an entrance slit in front of the spectroscopic optics to allow only a certain thickness of the line beam reflected from the measurement object to be incident.

Here, the spectroscopic reflectance image acquisition part may include spectroscopic optics that separates the line beam reflected from the measurement object by wavelength and a camera that acquires a two-dimensional spectroscopic reflectance image from the spectroscopic optics, and the image analysis processing part may use a wavelength map that matches a wavelength (λ) of the light received by each pixel (x pixel*y pixel) of the camera to obtain R(v, y) converted into a wavenumber (v=1/λ) from the spectroscopic reflectance image (R(x, y)), and perform Fourier transform on this in the v-axis direction, to obtain the thickness for each point of the line beam.

Here, the wavelength map may be formed by reflecting monochromatic or quasi-monochromatic light as a line beam to acquire a spectroscopic image, acquiring a plurality of spectroscopic images for different wavelengths, and then matching pixel areas where light of certain wavelengths is received.

Here, in a case where an intensity modulation according to the wavelength of the spectroscopic reflectance image is slow, the image analysis processing part may obtain the thickness regarding each point of the line beam through a direct comparison computation with a theoretical model of a spectroscopic reflectance signal instead of the Fourier transform of the acquired spectroscopic reflectance image.

Here, the line beam forming part, the bi-telecentric relay optical part, and the spectroscopic reflectance image acquisition part may be integrally formed to constitute a single measurement head capable of measuring thickness of a predetermined width, and the thickness may be measured while moving the single measurement head or moving the measurement object.

Here, the line beam forming part, the bi-telecentric relay optical part, and the spectroscopic reflectance image acquisition part may be integrally formed to constitute a single measurement head capable of measuring thickness with a predetermined width, and a plurality of measurement heads may be arranged in a spaced apart array form, and the thickness may be measured by moving the plurality of measurement heads or moving the measurement object.

As described above, the line spectroscopic reflectometry according to the present disclosure offers the advantage of significantly improving measurement speed compared to the conventional point measurement method by employing a line measurement method that performs parallel measurements of points along a line beam.

Additionally, there is the advantage that, by utilizing the bi-telecentric optics, it is possible to measure the thickness of objects with specular surfaces, such as glass substrates and optically clear resin (OCR), thereby reducing constraints on the specimens that can be measured.

Furthermore, there is the advantage that, since the angles of incidence and reflection are uniformly 90 degrees at all measurement points along the line beam, thickness may be obtained using the same computational model regardless of the measurement point, allowing for rapid thickness estimation.

Moreover, there is the advantage that, the high transmission efficiency of light being transmitted from the light source to the camera enables the acquisition of spectroscopic reflectance images with high signal intensity and a high signal-to-noise ratio, and thus the camera's exposure time can be minimized, allowing for high-speed thickness measurement within the maximum frame speed supported by the camera.

The effects of the present disclosure are not limited to those described above, and it should be understood that all effects derivable from the configuration of the present disclosure as described in the detailed description or claims are included.

### BRIEF DESCRIPTION OF THE DRAWINGS

FIG. 1 illustrates a schematic structure of line spectroscopic reflectometry according to a first embodiment of the present disclosure.

FIG. 2 shows a photograph of actual line spectroscopic reflectometry built based on FIG. 1.

FIG. 3 is a conceptual diagram of bi-telecentric optics.

FIG. 4(a) displays spectroscopic image data acquired by varying the wavelength values of a tunable wavelength light source, and FIG. 4(b) illustrates the wavelength map generated by analyzing FIG. 4(a).

FIG. 5 illustrates the process of obtaining thickness using the wavelength map in an image analysis processing part.

FIG. 6 illustrates a schematic structure of line spectroscopic reflectometry according to a second embodiment of the present disclosure.

FIG. 7 shows a schematic structure of line spectroscopic reflectometry according to a third embodiment of the present disclosure.

FIGS. 8(a)-8(b) are diagrams explaining the difference between a Powell lens and a cylindrical lens.

FIG. 9 is a diagram explaining the process of measuring the thickness of a multilayer specimen using the line spectroscopic reflectometry of FIG. 2.

FIG. 10 illustrates the thickness distribution measurement results for each of the multilayer specimen over area from FIG. 9.

FIGS. 11(a)-11(b) illustrate the measurement of thickness using line spectroscopic reflectometry configured with a single measurement head, as well as high-speed measurement of large-area thickness using line spectroscopic reflectometry composed of a plurality of measurement heads arranged in an array, according to the present disclosure.

### DETAILED DESCRIPTION

Specific details of the embodiments are included in the detailed description and drawings.

The advantages and features of the present disclosure, as well as the methods for achieving them, will become apparent with reference to the embodiments described in detail below in conjunction with the attached drawings. However, the present disclosure is not limited to the embodiments disclosed herein and may be implemented in various other forms. These embodiments are merely provided to ensure the completeness of the disclosure of the present disclosure and to fully convey the scope of the present disclosure to those skilled to which the present disclosure pertains. The present disclosure is defined only by the scope of the claims. Throughout the specification, the same reference numerals refer to the same components.

Hereinafter, the present disclosure will be described with reference to the drawings for explaining line spectroscopic reflectometry according to the embodiments of the present disclosure.

The line spectroscopic reflectometry according to the present disclosure can be applied to the following technical fields, enabling high-speed, large-area thickness measurement, but it is not limited to these and can be applied to various technical fields.
Display glass substrate manufacturing field: Display glass substrates vary in thickness from 0.2 to 0.7 mm, and during the large-area substrate manufacturing process, such as the fusion method, it is necessary to measure the thickness distribution in real-time and track the Total Thickness Variation (TTV) value. If the TTV exceeds a certain threshold, (1) constraints in process windows such as depth of focus (DOF) during the photo-lithography process will increase, and (2) variations in the thickness of liquid crystal cells may cause noticeable contrast deviations on the display screen, requiring thickness measurement.
Display lamination process field: In the lamination process of display panels, touchscreens, and cover glass, where layers are stacked and bonded together, a transparent adhesive called optically clear resin (OCR) has been widely used recently. OCR films, typically hundreds of micrometers thick, are usually created using slot-die coating. However, as recent automotive display screens are increasingly adopting free-form shapes rather than traditional rectangular shapes, the slot width of the coater must be adjustable during the coating process to match the irregular panel shapes. This can result in coating thickness non-uniformity, and thus rapid thickness measurement of the entire OCR-coated area is required to optimize the coating process and maintain consistent coating thickness quality.
Semiconductor carrier glass wafer manufacturing field: Carrier glass wafers vary in thickness from 0.1 to 0.5 mm, and the TTV of the wafer must be small to ensure uniform performance among semiconductor devices manufactured on a single wafer.
Other industrial fields

The line spectroscopic reflectometry may also be used for thickness measurement in the blown film extrusion process for agricultural or packaging films, or for thickness measurement in the manufacturing process of adhesive tapes such as Scotch tape.

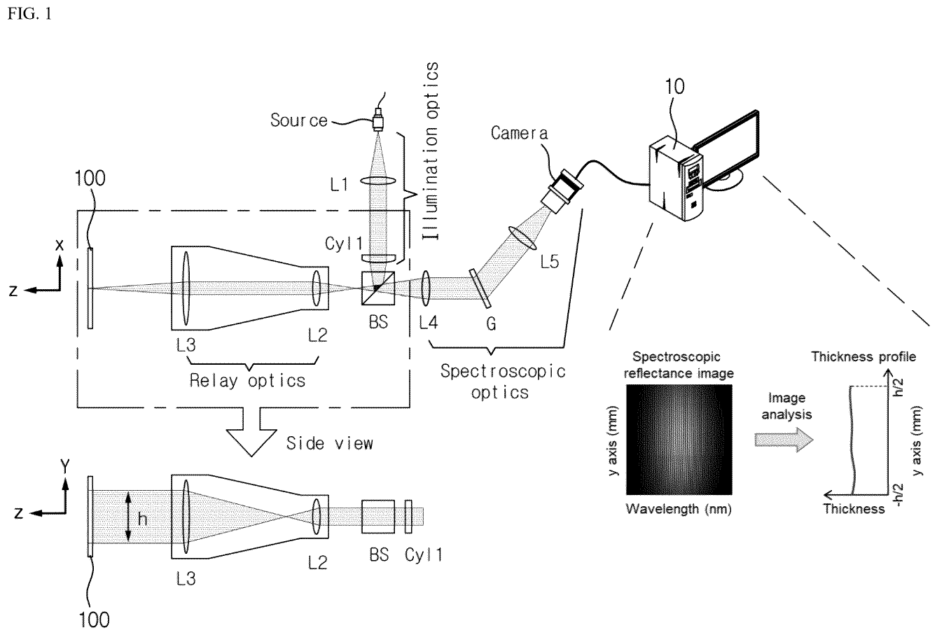

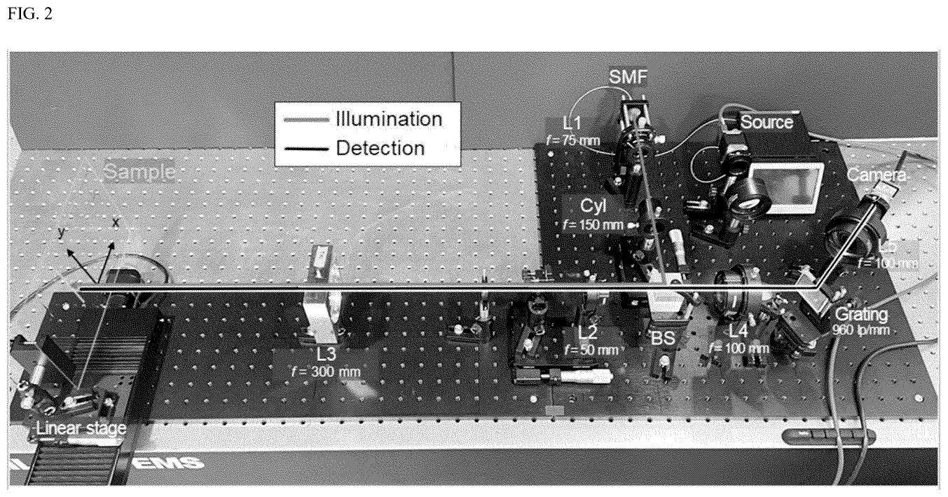

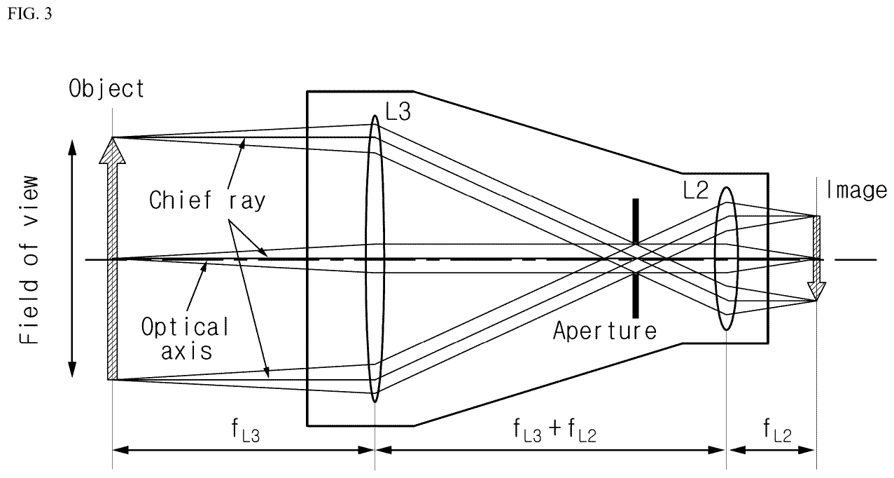

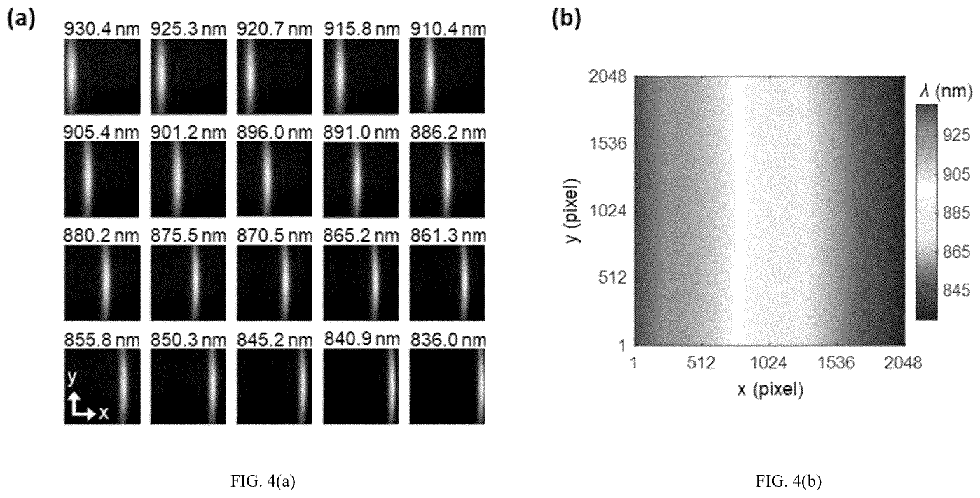

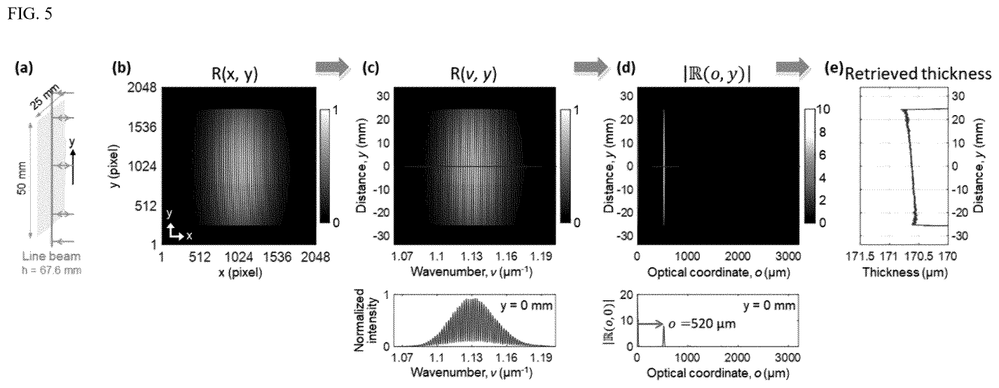

FIG. 1 illustrates a schematic structure of line spectroscopic reflectometry according to a first embodiment of the present disclosure, FIG. 2 shows a photograph of actual line spectroscopic reflectometry built based on FIG. 1, FIG. 3 is a conceptual diagram of bi-telecentric optics, FIG. 4(a) displays spectroscopic image data acquired by varying the wavelength values of a tunable wavelength light source, and FIG. 4(b) illustrates the wavelength map generated by analyzing FIG. 4(a), and FIG. 5 illustrates the process of obtaining thickness using the wavelength map in an image analysis processing part.

The line spectroscopic reflectometry according to the first embodiment of the present disclosure may be configured to include a line beam forming part, a bi-telecentric relay optical part, a spectroscopic reflectance image acquisition part, and an image analysis processing part 10.

The line beam forming part may be configured to include a light source and illumination optics.

The light source irradiates light with a broadband wavelength. For example, a broadband light source with a wavelength range of several tens of nanometers or more, such as an super-luminescent diode (SLD) or a supercontinuum laser, may be used. As a reference, these light sources are typically coupled with single-mode optical fibers, and only the end of the optical fiber is shown in FIG. 1.

The illumination optics converts the light irradiated from the light source into a line beam form. The illumination optics may be configured to include a lens (L1) that converts the diffused light irradiated from the light source into a circular collimated beam and a cylindrical lens (Cyl1) that focuses the circular collimated beam in one direction to form a line beam elongated in the y-direction. The illumination optics is not limited to the illustrated configuration and may be modified with other known optical configurations.

The light that passed through (Cyl1) is reflected by a beam splitter (BS) and irradiated toward a measurement object 100, preferably with the line beam focused in one direction by Cyl1 being generated in front of lens (L2) that forms the bi-telecentric relay optical part described later. In this embodiment, the line beam focused in one direction by Cyl1 is formed between L2 and the beam splitter, but the line beam may also be formed inside or in front of the beam splitter. For reference, in this specification, the side of the light source is referred to as the front, and the opposite side is referred to as the back, depending on the movement path of the light irradiated from the light source.

The beam splitter reflects light irradiated from the front line beam forming part toward the measurement object 100, and the light reflected from the measurement object 100 is transmitted toward the rear spectroscopic reflectance image acquisition part.

The bi-telecentric relay optics enlarges the line beam generated by the line beam forming part and directs it to be incident and reflected vertically on the measurement object 100.

The bi-telecentric relay optical part enlarges the line beam generated by the line beam forming part to form an illumination beam with a wider width (h), thereby increasing the measurement width.

Furthermore, by using the bi-telecentric optics to ensure that light is incident and reflected vertically on all measurement points along the line beam, and then passing it to the spectroscopic optics described later, the light detection efficiency of the reflectance signal is high and uniform, regardless of the position of the measurement points on the line beam.

Furthermore, if light is made to be vertically incident and reflected for all measurement points along the line by the bi-telecentric optics, the detection angle of the reflectance signal remains the same at 90 degrees regardless of the position of the measurement points on the line beam. If the detection angle of the reflectance signal varies with the position, the computational model required for thickness estimation would also need to change, which could increase the processing time for computation. However, by using the bi-telecentric optics as in the present disclosure, the detection angle of the reflectance signal is the same regardless of the position of the measurement points on the line beam, thus reducing the computation time for obtaining thickness using the same computational model.

As illustrated in FIG. 3, the bi-telecentric optics ensures that a chief ray is parallel to an optical axis in both an object space and an image space, maintaining a constant imaging magnification regardless of the object distance or position within the field of view. If there are lenses (L2, L3) with focal lengths f_{L2} and f_{L3}, the bi-telecentric optics may be constructed by arranging L2 and L3 with an object distance of f_{L3}, an image distance of f_{L2}, and a distance between the two lenses of f_{L2}+f_{L3}. In the bi-telecentric optics, the lens aperture of L2 is larger than the field of view, and the light transmission efficiency remains the same regardless of the position within the field of view.

Therefore, the line beam generated in the line beam forming part is enlarged by a ratio of f_{L3}:f_{L2} by the bi-telecentric relay optical part, thereby obtaining the desired illumination width (h). In this case, if the target illumination width in the field of view is 50 mm or larger, three or more lens groups may be required to maintain the optical performance of the large-aperture telecentric optics.

The spectroscopic reflectance image acquisition part separates the reflected line beam from the measurement object 100 by wavelength and acquires a spectroscopic reflectance image.

The spectroscopic reflectance image acquisition part may be composed to include spectroscopic optics and a camera. The spectroscopic optics may be composed of a diffraction grating (G) positioned between two lenses (L4, L5). In this case, to reduce chromatic aberration, a larger number of lenses may be used. In FIG. 1, a transmissive diffraction grating is shown, but a reflective diffraction grating may also be used.

Alternatively, in FIG. 1, concave mirrors may be used instead of L4 and L5 lenses, and a prism may be used instead of the diffraction grating to construct the spectroscopic optics. In this case, since concave mirrors are used, chromatic aberration does not occur in the spectroscopic optics. The composition of the spectroscopic optics is well-established, so a detailed explanation will be omitted.

The camera measures the optical signals separated by wavelength through the spectroscopic optics. In this case, the camera may acquire a two-dimensional spectroscopic reflectance image with an image sensor arranged in a horizontal (x pixel)*vertical (y pixel) layout. The spectroscopic reflectance image acquired from the camera may be transmitted to the image analysis processing part 10 and be processed.

The image analysis processing part 10 obtains the thickness of the measurement object 100 regarding the area where the line beam is irradiated, from the spectroscopic reflectance image acquired by the camera (the thickness distribution, not the average thickness of the area irradiated by the line beam). The image analysis processing part 10 may be composed of a computational processing device such as a computer.

First, in order to measure the thickness of the measurement object 100, the image analysis processing part 10 may use a wavelength map to convert the horizontal axis (x) of the two-dimensional spectroscopic reflectance image into light wavelength information. The process of obtaining the wavelength map will be described with reference to FIGS. 4(a)-4(b).

As shown in FIG. 4(a), monochromatic or quasi-monochromatic light is reflected as a line beam to acquire a spectroscopic reflectance image, and a plurality of spectroscopic images for different wavelengths may be obtained. For example, the light from the tunable wavelength laser light source is coupled into a single-mode fiber (SMF) and temporarily connected to the system implemented as shown in FIG. 2, with a mirror positioned in place of the specimen 100. Additionally, the output wavelength of the tunable wavelength laser light source is swept within the range of the SLD light source, and two-dimensional spectroscopic reflectance images for multiple wavelength values can be sequentially obtained. In this case, instead of the tunable wavelength laser light source, a monochromator may be connected to a broadband light source to vary the output wavelength. In FIG. 4(a), 20 spectroscopic reflectance images were acquired by changing the wavelength.

At this time, the horizontal (x) cross-sectional intensity profile data from each spectroscopic reflectance image is fitted to a skewed Gaussian model function to locate the x position of the peak intensity with sub-pixel accuracy. This process is repeated for each spectroscopic reflectance image from y=1 pixel to y=2048 pixels to obtain the results. The N (20 in FIG. 4(a)) constant wavelength line data obtained in this manner is then fitted to a third-degree xy polynomial function model, and as shown in FIG. 4(b), a two-dimensional wavelength map with wavelength values (λ) assigned over the entire pixels (2048×2048) of the camera may be obtained.

Next, the process of obtaining the thickness from the spectroscopic reflectance image using the wavelength map in the image analysis processing part 10 will be explained with reference to FIG. 5.

As shown in (a) of FIG. 5, a line beam was irradiated according to the present disclosure in the 50 mm length direction on a microscope coverslip (size: 25 mm×50 mm) with a thickness of 170±5 μm, and the spectroscopic reflectance image acquisition part acquired a spectroscopic reflectance image R(x, y) as shown in (b) of FIG. 5. When the intensity modulation of the spectroscopic reflectance signal with respect to the wavelength is rapid, the thickness of the specimen 100 may be effectively estimated simply by Fourier transform, without the need for comparison calculations with the theoretical model of the spectroscopic reflectance signal. To do this, using the wavelength map described with reference to FIG. 4(b), the horizontal axis of R(x, y) is converted to the wavenumber (v=1/λ) to obtain R(v, y) as shown in (c) of FIG. 5, and performing one-dimensional Fourier transform on this image in the horizontal axis direction gives (d) of FIG. 5. At this point, the horizontal axis is converted into the ‘optical coordinate’ (o) in the wavenumber (v) space, and R(o, y) is obtained. For a specific y position (y=0), the optical coordinate o value corresponding to the first peak of the absolute value signal of R(o, y) is proportional to the thickness of the specimen 100. When the light is incident perpendicularly to the specimen 100, the thickness (d) of the specimen 100 may be determined as d=o/(2n_{eff}). Here, n_{eff} is the effective refractive index of the material of the specimen 100. For example, by looking at the cross-sectional profile at the bottom of (d) in FIG. 5, the first peak occurs at o=˜520 μm, and since the effective refractive index of the coverslip material (D 263 M, Schott) within the wavelength range used by the system is approximately 1.5284, the thickness of the specimen 100 at the y=0 mm position may be calculated as d=170.1 μm. At this point, by changing the y-axis position in (d) of FIG. 5 and repeating the process of finding the optical coordinate o value corresponding to the first peak of the absolute value signal of R(o, y) in the same way, the thickness distribution for the 50 mm length of the coverslip may be obtained as shown in (c) of FIG. 5.

As described above, the image analysis processing part 10 uses the wavelength map, which matches the wavelength (λ) of the light received by each pixel (x pixel*y pixel) of the camera, to convert the spectroscopic reflectance image (R(x, y)) into R(v, y) by transforming it into wavenumber (v=1/λ), and then performs Fourier transform in the v axis direction. This method allows the thickness distribution of the area irradiated by the line beam to be determined for each point (y) on the line beam.

In cases where the intensity modulation of the spectroscopic reflectance signal regarding the wavelength is not rapid, the image analysis processing part 10 may also obtain the thickness for each point on the line beam by performing a comparison computation between the spectroscopic reflectance image acquired from the spectroscopic reflectance image acquisition part and the theoretical model of the spectroscopic reflectance signal.

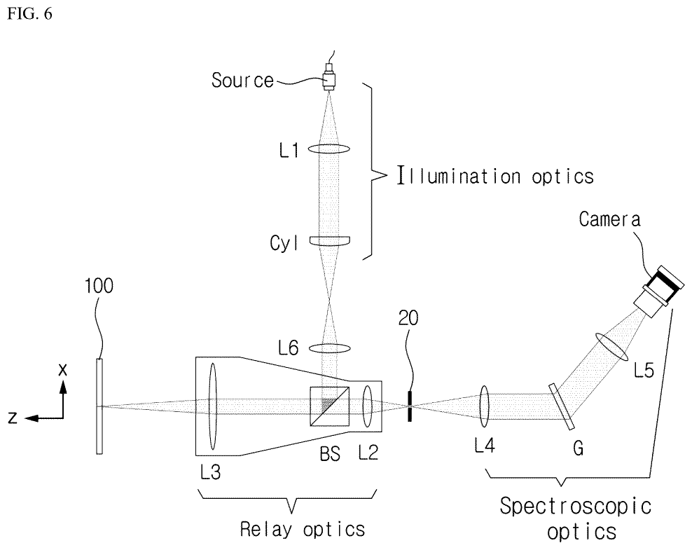

FIG. 6 is a diagram showing the approximate structure of line spectroscopic reflectometry according to the second embodiment of the present disclosure.

In the following description, the differences from the embodiment described with reference to FIGS. 1 to 5 will be explained. It should be noted that the image analysis processing part 10 is not shown in FIG. 6.

As shown in FIG. 1, when the circular collimated beam behind the L1 lens is focused by the Cyl1, the x-direction thickness and light intensity of the line beam vary somewhat depending on the position in the y-direction. That is, the beam width increases and the light intensity decreases as it goes toward both ends of the line beam. When the width of the line beam increases, the spectral resolution of the spectroscopic optics decreases, which may reduce the accuracy of thickness measurement and narrow the range of measurable thickness. To address this, in this embodiment, an entrance slit 20 may be further included in front of the spectroscopic optics to ensure that only a certain thickness of the line beam reflected from the measurement object 100 enters the spectroscopic optics. Therefore, regardless of the position of the line beam in the y-direction, the resolution performance of the spectroscopic optics can be kept uniform, solving the above problem.

In this case, the entrance slit 20 may be positioned at the point where the line beam reflected from the measurement object 100 is focused as shown in FIG. 6. Accordingly, compared to the previous description in FIG. 1, an L6 lens is added at the line beam forming part's side, and the beam splitter may be placed between L2 and L3. The lens (L6) and L3 may form bi-telecentric optics regarding the incident light toward the measurement object 100, and L3 and L2 may form bi-telecentric optics for the reflected light reflected from the measurement object 100. Therefore, in this embodiment, the line beam formed in the line beam forming part may be formed in front of L6.

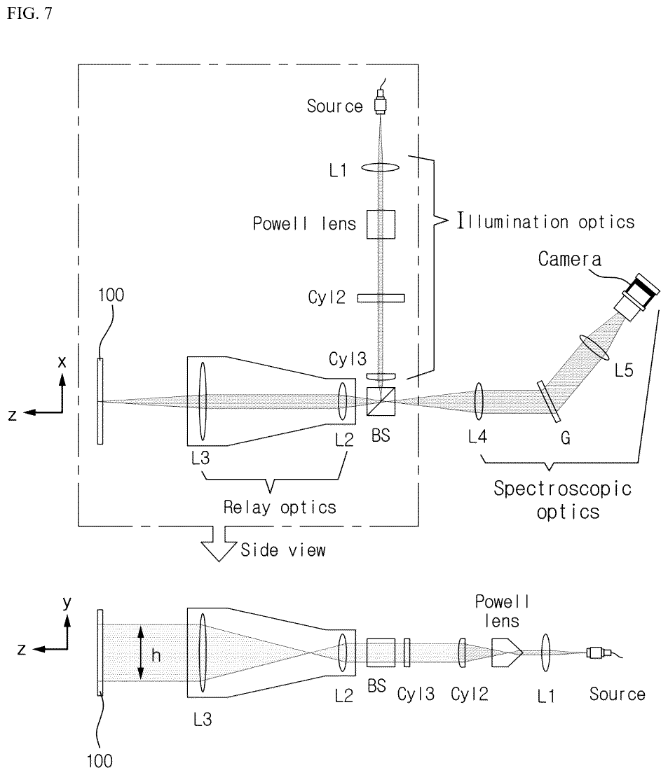

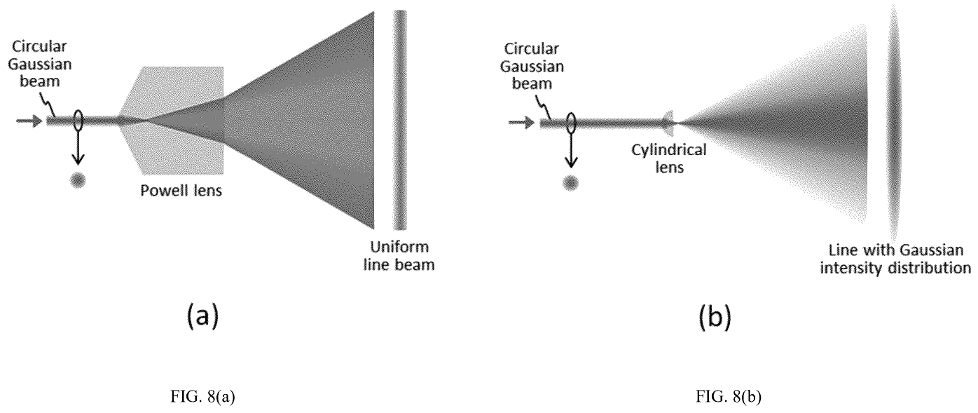

FIG. 7 is a diagram showing the approximate structure of line spectroscopic reflectometry according to the third embodiment of the present disclosure, and FIGS. 8(a)-8(b) are diagrams explaining the difference between a Powell lens and a cylindrical lens.

In the following description, the differences from the embodiment described with reference to FIGS. 1 to 5 will be explained. It should be noted that the image analysis processing part 10 is not shown in FIG. 7.

As described above, when the circular collimated beam behind the L1 lens is focused by the Cyl1, the x-direction thickness and the light intensity of the line beam vary depending on the position in the y-direction. Therefore, in this embodiment, a Powell lens is used to generate a line beam with uniform beam thickness and light intensity within the illumination width (h).

As shown in FIG. 8(a), when a circular Gaussian profile beam passes through the Powell lens, the light only spreads in the vertical direction, forming a beam with uniform intensity in the vertical direction. On the other hand, as shown in FIG. 8(b), when a circular Gaussian profile beam passes through a cylindrical lens, the Gaussian profile is maintained, and the light at the upper and lower ends becomes much darker compared to the center.

Thus, in this embodiment, the Powell lens is placed behind the lens (L1) that converts the diverging light from the light source into a circular collimated beam. This generates an illumination beam with a uniform width and uniform intensity.

The beam is then collimated by the cylindrical lens (Cyl2) and focused in only one direction by the cylindrical lens (Cyl3), thereby generating an improved line beam compared to the previous embodiment. The Cyl3, which is used to focus the light in one direction, is placed behind the Cyl2 in FIG. 7, but depending on the design, Cyl3 may also be placed in a different position between L1 and the beam splitter.

Therefore, in this embodiment, compared to the embodiment of FIG. 1, the accuracy of thickness measurement is maintained uniformly even at both ends of the line beam in the y-direction as it is at the center of the y-direction, which improves the overall thickness measurement accuracy and increases the measurable thickness range. Furthermore, while maintaining a uniform thickness in the x-direction of the line beam, the y-direction width (h) of the line beam can be easily increased, which allows for an increased measurement speed over a large area.

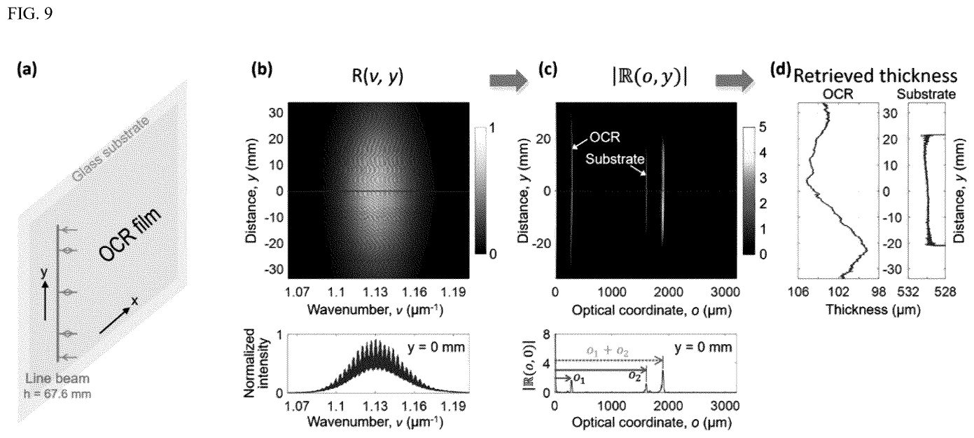

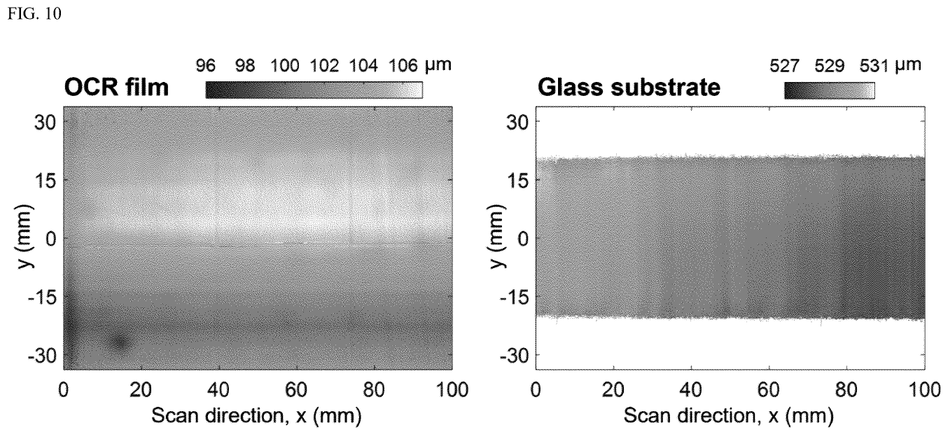

FIG. 9 is a diagram explaining the thickness measurement process of a multilayer specimen using the line spectroscopic reflectometry of FIG. 2, and FIG. 10 shows the thickness distribution measurement results over the area for each multilayer specimen in FIG. 9.

The line spectroscopic reflectometry according to the present disclosure may also measure the thickness of a multilayer specimen 100.

As shown in (a) of FIG. 9, the thickness of a multilayer specimen 100 with OCR coated on a soda-lime glass substrate was measured using the line spectroscopic reflectometry of FIG. 2. (b) of FIG. 9 shows the R(v, y) spectroscopic reflectance image, obtained for the multilayer specimen using the line spectroscopic reflectometry according to the present disclosure, where the horizontal axis has been converted to wavenumber using the wavelength map as described above. At this point, when the spectroscopic reflectance image converted to R(v, y) is one-dimensional Fourier transformed in the horizontal (v) direction as described above, the R(o, y) image showing multiple peaks in the “optical coordinate” space, as shown in (c) of FIG. 9 may be acquired. Here, as shown at the bottom of (c) of FIG. 9, for a specific y position (y=0), the first peak (o₁=˜293 μm) of the R(o, y) absolute value signal corresponds to the OCR film thickness, the second peak (o₂=˜1607 μm) corresponds to the glass substrate thickness, and the third peak (o1+o2) is a signal related to the sum of the two layer thicknesses. As such, by varying the y-axis position and repeating the process of finding the optical coordinate o values corresponding to the peak of the R(o, y) absolute value signal in the same manner as described above, the OCR film thickness and the thickness distribution of the glass substrate for the area irradiated by the line beam may be obtained, as shown in (d) of FIG. 9.

For reference, the multilayer specimen 100 in (a) of FIG. 9 was moved at a speed of 3.0 mm/s along the x-axis while continuously acquiring two-dimensional spectroscopic reflectance images at a rate of 90 frames per second. These images were then analyzed, and the thickness distribution for the entire area of the multilayer specimen 100 is shown in FIG. 10.

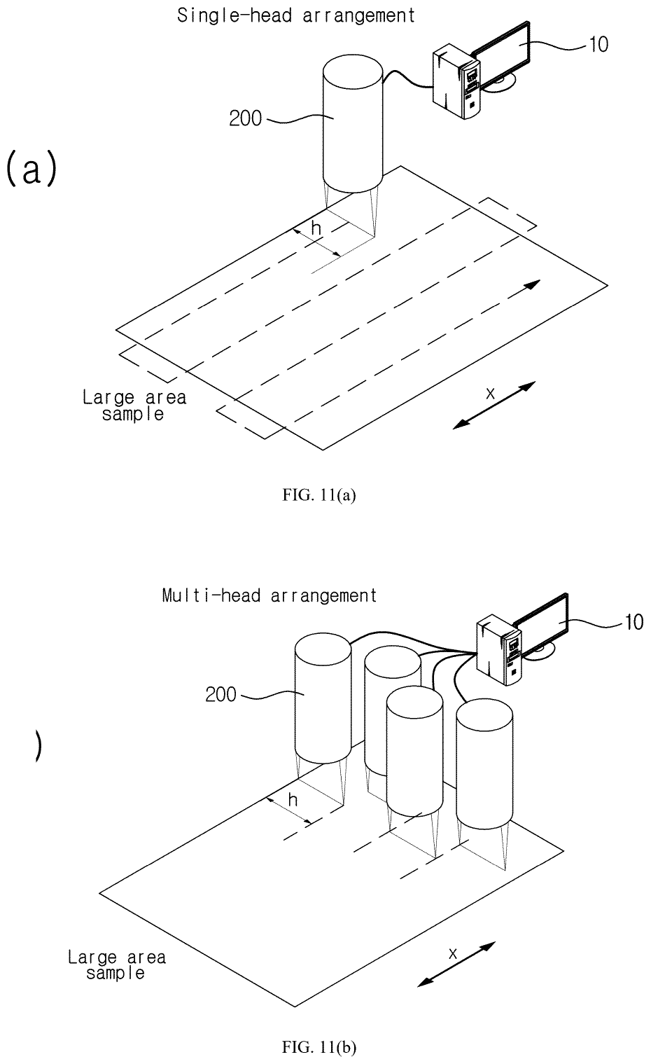

FIGS. 11(a)-11(b) illustrate the measurement of thickness using line spectroscopic reflectometry configured with a single measurement head, as well as high-speed measurement of large-area thickness using line spectroscopic reflectometry composed of multiple measurement heads arranged in an array, according to the present disclosure.

The line beam forming part, the bi-telecentric relay optical part, and the spectroscopic reflectance image acquisition part may be integrally formed to create a single measurement head 200. Therefore, as shown in FIG. 11(a), by irradiating the line beam within a predetermined range (h), the thickness may be measured by either moving the single measurement head 200 in the X direction or Y direction, or moving the measurement object 100 in the X direction or Y direction, allowing the thickness to be measured over the entire area.

Alternatively, as shown in FIG. 11(b), by providing a plurality of measurement heads capable of measuring thickness within the predetermined width (h) and arranging them in a spaced apart array form on a gantry, the thickness may be measured over the entire area by moving the gantry or the measurement object 100 in the X direction in a one-dimensional manner.

The embodiments of the present disclosure have been described with reference to the attached drawings, but those skilled in the art to which the present disclosure pertains will understand that the present disclosure can be carried out in other specific forms without changing its technical spirit or essential characteristics. Therefore, the embodiments described above should be understood as illustrative in all respects and not restrictive.

### REFERENCE NUMERALS

10: IMAGE ANALYSIS PROCESSING PART
20: ENTRANCE SLIT
100: MEASUREMENT OBJECT, SPECIMEN
200: MEASUREMENT HEAD
Cyl1, Cyl2, Cyl3: CYLINDRICAL LENSES
L1, L2, L3, L4, L5, L6: LENSES

What is claimed is:

1. Line spectroscopic reflectometry comprising:
a line beam forming part configured to generate a line beam from a light source irradiating a broadband wavelength;
a bi-telecentric relay optical part that uses bi-telecentric optics to enlarge the line beam generated by the line beam forming part and vertically irradiates and reflects it onto a measurement object;
a spectroscopic reflectance image acquisition part configured to separate the reflected line beam from the measurement object by wavelength to acquire a spectroscopic reflectance image; and
an image analysis processing part that obtains a thickness of the measurement object from the spectroscopic reflectance image for a region where the line beam is irradiated onto the measurement object.

2. The line spectroscopic reflectometry according to claim 1,
further comprising a beam splitter configured to reflect the light irradiated from the line beam forming part toward the measurement object and to transmit the light reflected from the measurement object toward the spectroscopic reflectance image acquisition part.

3. The line spectroscopic reflectometry according to claim 2,
wherein the line beam forming part comprises a lens (L1) configured to convert the light irradiated from the light source into a circular collimated beam, and a cylindrical lens (Cyl1) configured to focus the circular collimated beam in one direction.

4. The line spectroscopic reflectometry according to claim 2,
wherein the line beam forming part comprises a lens (L1) that makes a circular collimated beam from the light emitted from the light source, a Powell lens that is disposed behind the L1 and expands the light in one direction, a cylindrical lens (Cyl2) that is disposed behind the Powell lens and collimates the light, and a cylindrical lens (Cyl3) that is disposed behind the L1 and focuses the light in one direction.

5. The line spectroscopic reflectometry according to claim 1,
wherein the bi-telecentric relay optical part comprises a lens (L2) disposed at an image space's side and a lens (L3) disposed at an object space's side, and a distance between the L2 and the L3 is equal to a sum of their focal lengths, and
the line beam focused by the line beam forming part is generated in front of the L2.

6. The line spectroscopic reflectometry according to claim 4,
wherein the bi-telecentric relay optical part comprises a lens (L2) disposed at an image space's side and a lens (L3) disposed at an object space's side, and a distance between the L2 and the L3 is equal to a sum of their focal lengths, and
the line beam focused by the line beam forming part is generated in front of the L2.

7. The line spectroscopic reflectometry according to claim 3,
wherein the bi-telecentric relay optical part further comprises a lens (L2) disposed at an image space's side, a lens (L3) disposed at an object space's side, and a lens (L6) disposed in front of the beam splitter at the line beam forming part's side,
the beam splitter is disposed between the L2 and the L3,
a distance between the L2 and the L3 is equal to a sum of their focal lengths, so that the L2 and the L3 form bi-telecentric optics regarding the reflected light reflected from the measurement object, and
a distance between the L6 and the L3 is equal to a sum of their focal lengths, so that the L6 and the L3 form bi-telecentric optics regarding the incident light toward the measurement object.

8. The line spectroscopic reflectometry according to claim 6,
wherein the spectroscopic reflectance image acquisition part comprises spectroscopic optics configured to separate the line beam reflected from the measurement object by wavelength and a camera configured to acquire a two-dimensional spectroscopic reflectance image from the spectroscopic optics, and
further comprises an entrance slit in front of the spectroscopic optics to allow only a certain thickness of the line beam reflected from the measurement object to be incident.

9. The line spectroscopic reflectometry according to claim 1,
wherein the spectroscopic reflectance image acquisition part comprises spectroscopic optics configured to separate the line beam reflected from the measurement object by wavelength and a camera configured to acquire a two-dimensional spectroscopic reflectance image from the spectroscopic optics, and
the image analysis processing part uses a wavelength map that matches a wavelength (λ) of the light received by each pixel (x pixel*y pixel) of the camera to obtain R(v, y) converted into a wavenumber (v=1/λ) from the spectroscopic reflectance image (R(x, y)), and performs Fourier transform on this in the v-axis direction, to obtain the thickness for each point of the line beam.

10. The line spectroscopic reflectometry according to claim 9,
wherein the wavelength map is formed by reflecting monochromatic or quasi-monochromatic light as a line beam to acquire a spectroscopic image, acquiring a plurality of spectroscopic images for different wavelengths, and then matching pixel areas where light of certain wavelengths is received.

11. The line spectroscopic reflectometry according to claim 1,
wherein the image analysis processing part obtains the thickness regarding each point of the line beam through a comparison computation between the acquired spectroscopic reflectance image and a theoretical model of a spectroscopic reflectance signal.

12. The line spectroscopic reflectometry according to claim 1,
wherein the line beam forming part, the bi-telecentric relay optical part, and the spectroscopic reflectance image acquisition part are integrally formed to constitute a single measurement head capable of measuring thickness of a predetermined width, and the thickness is measured while moving the single measurement head or moving the measurement object.

13. The line spectroscopic reflectometry according to claim 1,
wherein the line beam forming part, the bi-telecentric relay optical part, and the spectroscopic reflectance image acquisition part are integrally formed to constitute a single measurement head capable of measuring thickness with a predetermined width, and a plurality of measurement heads are arranged in a spaced apart array form, and the thickness is measured by moving the plurality of measurement heads or moving the measurement object.
